(19) United States
(12) Patent Application Publication
(10) Pub. No.: US 2008/0258686 A1
(43) Pub. Date: Oct. 23, 2008

(54) Method for Detecting Removal of a Battery from a Battery Charger

(75) Inventors: Thomas Li, Fremont, CA (US); John S.K. So, Fremont, CA (US); David Yen Wai Wong, Sunnyvale, CA (US)

Correspondence Address: ADVANCED ANALOGIC TECHNOLOGIES, 3230 Scott Blvd, Santa Clara, CA, 95054, US

(73) Assignee: ADVANCED ANALOGIC TECHNOLOGIES, INC., Sunnyvale, CA (US)

(21) Appl. No.: 11/736,375

(22) Filed: Apr. 17, 2007

(51) Int. Cl. H02J 7/00

(52) U.S. Cl. 320/134

(57) ABSTRACT

A method for detecting removal of a battery from a battery charger includes 1) incrementing an event counter and resetting an interval counter each time the voltage present at the output node exceeds a predetermined voltage; 2) resetting the event counter each time the interval counter exceeds a predetermined maximum time between events; and 3) asserting a signal indicating the absence of a battery connected between the positive and negative output nodes each time event counter exceeds a predetermined number of events.

### BACKGROUND OF THE INVENTION

FIG. 1 shows a typical batter charger of a type commonly used for Li-ion battery charging. The basic function of the battery charger is to control the current flowing between an input voltage (represented as a positive voltage (V+) and a negative voltage (V−)) and a Li-ion battery. The current is optimally controlled according to a predetermined algorithm optimized to match the chemistry (in this case Li-ion) of the battery being charged.

Most battery chargers are either of the switching type or the linear regulator type. The battery charger in FIG. 1 is of the second type and includes a transistor M₁ connected to control the current flowing to the battery being charged. To determine the rate of charging two types of feedback are used: current feedback and output voltage feedback. A current sense resistor R₁ and an amplifier are used to measure the current flowing to the battery and generate the current feedback signal labeled C_{FB}. A voltage divider that includes the resistor R₂ and the resistor R₃ is used to provide the voltage feedback signal V_{FB}.

A linear mode charge controller monitors the current feedback signal C_{FB} and the voltage feedback V_{FB} and adjusts the operation of transistor M₁ to charge the battery. An output capacitor is connected in parallel with the battery. The output capacitor provides stability to the system when the battery is disconnected.

Switching battery chargers are similar in many ways to the linear battery charger just described. As shown in FIG. 2, a charger of this type includes two switching transistors configured as a step down or buck converter. The two transistors operate out of phase and the duty cycle of the two switches is varied in response to the current feedback signal C_{FB} and the voltage feedback V_{FB} to charge the battery according to a predetermined algorithm. The linear mode charger has widely been used because of its simplicity and low system cost. Accuracy of +/−1% EOC (End of Charge) voltage over operational temperatures required by various Li-ion battery manufacturers is easy to meet with the linear mode charger. The linear battery charger may be simple, but as batteries increase in size and charging currents increase, power dissipation becomes a problem. The switch mode charger is the alternative solution because of its efficiency. Typically, the linear charger will reach its power dissipation limit with approximately 1 amp of charging current at a moderate input to output voltage differential. On the other hand, the high efficiency of the switch mode charger can extend the charging current beyond 2 amps even with a high input to output voltage differential. Like the linear charger, the switch mode charger has its drawbacks. Besides system cost due to the required inductor, the switch mode charger suffers inaccurate low level current regulation caused by ripple current, input/output impedance mismatch induced oscillation tendencies, hot plug inductance induced voltage spiking and light load current induced electromagnetic noise generation.

As shown in FIG. 3, up to three charging modes are used to charge a Lithium-ion battery. For a deeply discharged cell, a preconditioning current of approximately 10% of the maximum charge current is first applied to slowly charge the cell up to a level where it can accept the maximum charge current. If the cell is not as deeply discharged and its voltage is already above this threshold, then the maximum charge current is applied and the preconditioning current is not required. The maximum charging current is applied until the battery voltage reaches its regulated voltage level threshold. Once the regulated voltage threshold has been detected, the charger regulates the battery voltage until the charge current drops to approximately 10% of the maximum charge current, stops charging, and the charge is complete. This last mode is referred to as constant voltage mode charging.

### SUMMARY OF THE INVENTION

The present invention provides a method for detecting a “no battery” condition for use with battery chargers. The no battery detect method assumes that a battery charger includes an output capacitor connected in parallel with the battery being charged. The method also requires some method for monitoring the voltage over the capacitor (or an equivalent or corresponding voltage).

To detect the no battery condition, the battery charger is configured to maintain two counters: an event counter and an interval counter. Each counter is initially set to zero. The battery charger increments the event counter and resets the interval counter each time a high voltage event is detected (a high voltage event is defined to as the condition where the output voltage of the battery charger exceeds the constant-voltage-mode voltage (typically 4.2 volts)).

The interval counter is incremented with each cycle of an internal oscillator. Since it is reset with each high-voltage-event, the interval counter corresponds to the amount of time that has elapsed since the last high voltage event. If the interval counter reaches a predetermined limit, the event counter is reset to zero. If this does not happen, the event counter will continue to increment. If it reaches another predetermined limit, the battery charger asserts a signal indicating that the no battery condition has been detected. In effect, a predetermined number of high-voltage-events occurring within a predetermined time period is used to detect the lack of a battery.

### BRIEF DESCRIPTION OF THE DRAWINGS

FIG. 1 is a block diagram of a prior art linear mode charger.

FIG. 2 is a block diagram of a prior art switching mode charger.

FIG. 3 shows a charging profile representative of the output of a typical prior art Li-ion battery charger.

FIG. 4 shows the components typically added to a battery charger to implement the no battery detection method.

FIG. 5 is a plot showing the relationship between the output of a battery charger and the CVM signal generated by the apparatus of FIG. 4.

FIG. 6 is a flowchart showing the steps associated with a software implementation of the no battery detect method of the present invention.

### DETAILED DESCRIPTION OF THE PREFERRED EMBODIMENTS

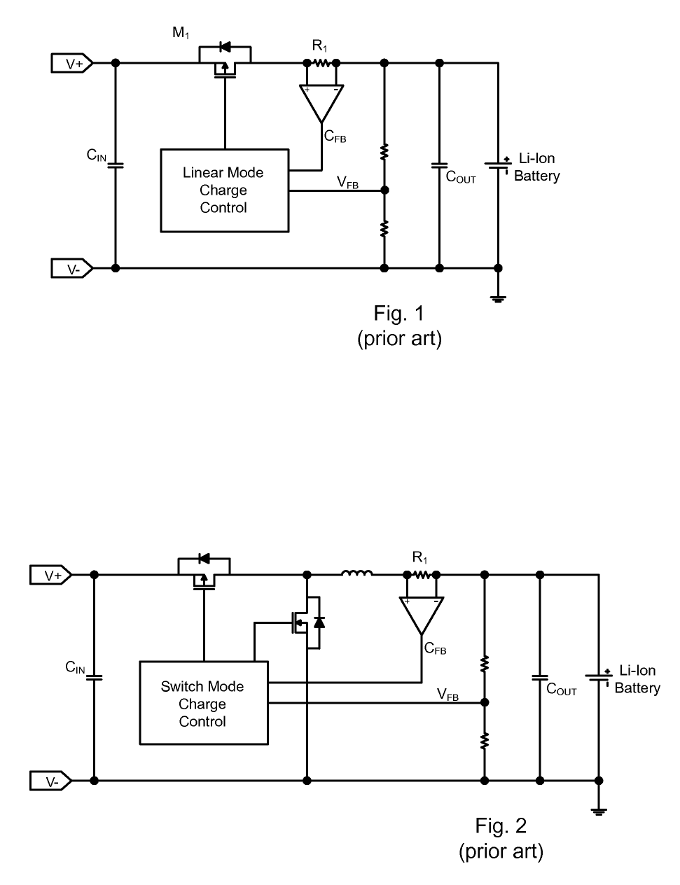

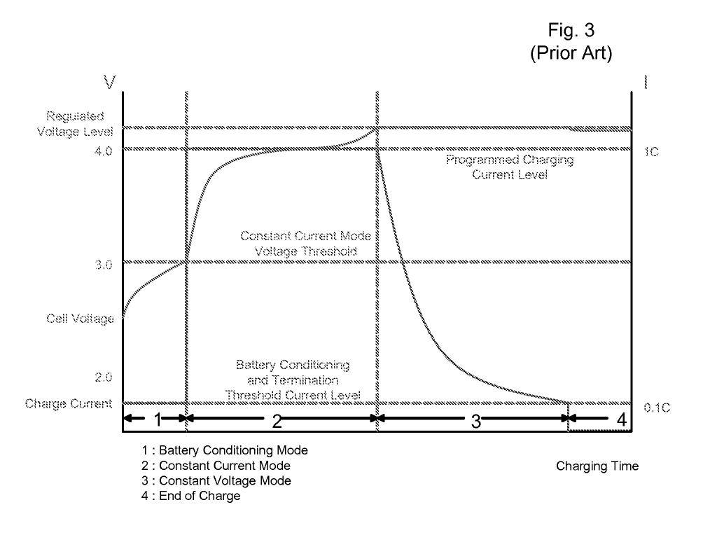

The present invention provides a method and apparatus that allows battery chargers to detect when a battery under charge has been removed or is otherwise absent (a “no battery” condition). The no battery detection method is intended for use with all battery charger types including the linear and switching types shown in FIG. 1 and FIG. 2. In fact, any battery charger that includes an output capacitor connected in parallel with the battery being charged and some method for monitoring the voltage over the capacitor may be adapted to use the no battery detection method.

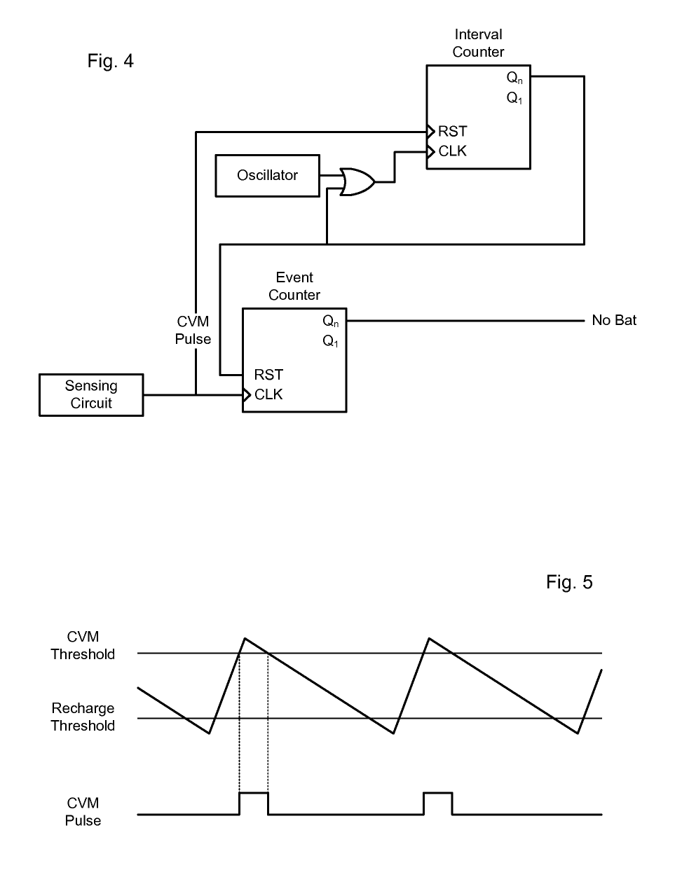

FIG. 4 shows the components typically added to a battery charger to implement the no battery detection method. As shown in FIG. 4, these components include: an event counter, an interval counter, a sensing circuit and an oscillator. The sensing circuit monitors the output of the battery charger and generates a CVM pulse signal whenever the output of the charger exceeds a predetermined voltage. Typically, the predetermined voltage is the predetermined constant voltage mode voltage of the battery charger. The CVM pulse signal is supplied to the reset input (RST) of the interval counter and the clock input (CLK) of the event counter. As a result, each high-voltage event (defined as a condition where the voltage produced by the battery charger exceeds its constant voltage mode voltage) causes the interval counter to be initialized to zero and causes the event counter to be incremented.

The oscillator is connected to the clock input (CLK) of the interval counter. As a result, the interval counter is incremented at a predetermined rate equal to the frequency of the oscillator. The high order bit output of the interval counter is connected to the reset input (RST) of the event counter. As a result, the event counter is reset to zero whenever the interval counter reaches a predetermined count. In this document, this predetermined count may be referred to as the “maximum time between events.”

The interval counter and event counter are initially set to zero. Each high voltage event increments the event counter and causes the interval counter to begin counting. If the interval counter reaches the maximum time between events, it causes the event counter to be reset to zero and the process starts over again. On the other hand, if a subsequent high voltage event occurs before the interval counter reaches the maximum time between events, the event counter is once again incremented and the interval counter reset to zero. If this happens a predetermined number of times (i.e., if a predetermined number of high voltage events occur without the interval resetting the event counter) the event counter will eventually reach its own predetermined limit. This causes a “no battery” signal to be driven high. This signal may be used in turn, to enable an indicator light or perform any task relevant to the condition in which no battery is present. This predetermined limit may vary between different implementation and may be referred to as the “number of events.”

As may be appreciated from the foregoing, the event counter is typically intended to count a relatively small number of high voltage events before asserting the no battery signal. For this reason, the event counter is preferably implemented as a shift register although other counter types may be used.

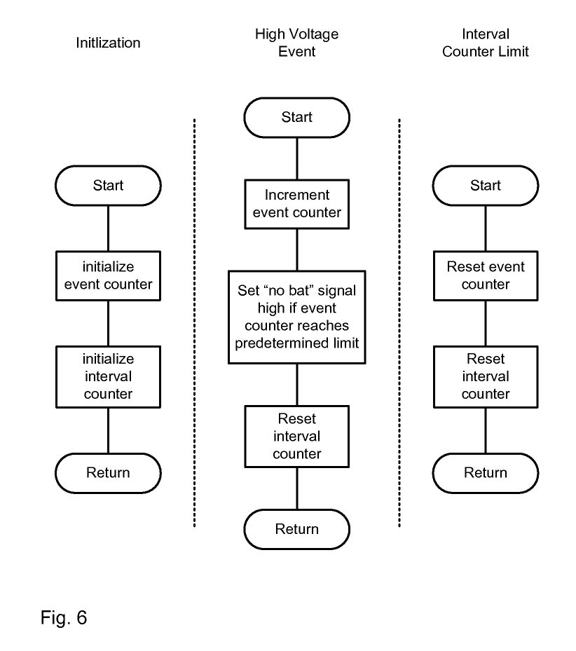

As discussed above, FIG. 5 shows the components typically added to a battery charger to implement the no battery detection method. As may be appreciated, these components are physical hardware. It may also be appreciated that the no battery detection method could also be implemented as series of steps performed by a microprocessor or state machine. FIG. 6 shows a representative series of steps of this nature subdivided as an initialization process flow, a high voltage event process flow and an interval timer limit process flow. The initialization process flow is called to start the no battery detection method and includes the steps of initializing the event counter and the interval counter to their initial state (typically zero or one).

The high voltage event process flow is called when a high voltage event is detected. At that time, the event counter is incremented. In the following step, the “no battery” signal is driven logically high if the event counter has reached the predetermined event limit. In the following step, the interval counter is reset to zero preparing it to measure the amount of time that will elapse before the next high voltage event occurs.

The interval timer limit process flow is called when the interval timer reaches the maximum time between events. This means that an extended period (i.e., a period that exceeds the predetermined limit of the interval counter) has elapsed since the last high voltage even. For this reasons, the interval counter and the event counter are both reset to zero (or the appropriate initial values).

By calling the three process flows at the appropriate times, a microprocessor may cause the “no battery” signal to be activated whenever a battery being charged is disconnected from its charger.

What is claimed is:

1. A method for detecting removal of a battery from a battery charger, where the battery charger includes a positive output node, a negative output node and a capacitor connected between the positive and negative output nodes, the method comprising:
incrementing an event counter and resetting an interval counter each time an event occurs where an event is defined to have occurred whenever the voltage at the output node exceeds a predetermined voltage;
resetting the event counter each time the interval counter exceeds a predetermined maximum time between events; and
asserting a signal indicating the absence of a battery connected between the positive and negative output nodes each time event counter exceeds a predetermined number of events.

2. A method as recited in claim 1 that further comprises:
incrementing the interval counter synchronously with an oscillator signal.

3. A method as recited in claim 1 in which the predetermined voltage is equal to the constant voltage mode voltage that the battery charger uses for the type of battery being charged.

4. A method as recited in claim 1 where the type of battery being charged is a Lithium Ion battery.

5. An apparatus for detecting removal of a battery from a battery charger, where the battery charger includes a positive output node, a negative output node and a capacitor connected between the positive and negative output nodes, the method comprising:
an event counter;
an interval counter;
a first circuit configured to increment the event counter and resetting the interval counter each time an event occurs where an event is defined to have occurred whenever the voltage at the output node exceeds a predetermined voltage;
a second circuit configured to reset the event counter each time the interval counter exceeds a predetermined maximum time between events; and
a third circuit configured to assert a signal indicating the absence of a battery connected between the positive and negative output nodes each time event counter exceeds a predetermined number of events.

6. An apparatus as recited in claim 5 in which the interval counter is connected to be incremented synchronously with an oscillator signal.

7. An apparatus as recited in claim 5 in which the predetermined voltage is equal to the constant voltage mode voltage that the battery charger uses for the type of battery being charged.

8. An apparatus as recited in claim 5 in which the type of battery being charged is a Lithium Ion battery.
